(19) United States
(12) Patent Application Publication
(10) Pub. No.: US 2008/0174992 A1
(43) Pub. Date: Jul. 24, 2008

(54) Modularized transformation structure for lamp tube

(76) Inventor: Li-Hua Lin, Taipei Hsien (TW)

Correspondence Address: TROXELL LAW OFFICE PLLC;Suite 1404, 5205 Leesburg Pike, Falls Church, VA, 22041, US

(21) Appl. No.: 11/657,125

(22) Filed: Jan. 24, 2007

(51) Int. Cl. F21S 4/00

(52) U.S. Cl. 362/217

(57) ABSTRACT

A modularized transformation structure for a lamp tube comprises two lamp holders, a lamp tube, two adapters, a lamp tube holder, and an electronic ballast. The adapters are attached to both ends of the lamp tube holder. Each of the adapters has an insertion trench for insertion thereinto of lamp pins on each end of the lamp tube. Each of the adapters has insertion terminals on the outer lateral for coupling with the lamp holders. The electronic ballast is mounted on the inside of the lamp tube holder for connection with the lamp pins on both ends of the lamp tube. The electronic ballast has two outputs on both ends for respective connection with one lamp holder and an inductive ballast via the other lamp holder. Accordingly, the adapters can be attached to both ends of the lamp tube easily to compensate for the insufficient length of the lamp tube.

### FIELD OF THE INVENTION

The present invention relates to a modularized transformation structure, and more particularly to a modularized transformation structure for a lamp tube for attaching to the old-type lamp holders so as to replace the old-type lamp tube.

### BACKGROUND OF THE INVENTION

As shown in FIG. 1, the conventional fluorescent lamp structure comprises a lamp tube 10 (T8 lamp tube), wherein one end of the lamp tube 10 is connected with an inductive ballast 20, and the lamp tube 10 is also series-connected with an actuator 30.

The existing fluorescent lamp structure, which is suitable for the T8 fluorescent lamp tube, usually includes a lamp bracket and two lamp holders fixed on both ends of the lamp bracket, wherein only the T8 lamp tube is applicable to the constant distance between these two lamp holders. The T5 or smaller lamp tube is not applicable to this constant distance between these two lamp holders. Accordingly, the original lamp bracket and these two lamp holders must be replaced and discarded, causing wastage. Moreover, the discard of commonly-used induction-type fluorescent lamp structures will cause very serious environmental problems.

Furthermore, the inductive ballast applied to the typical lamp structure is only suitable for the T8 or larger lamp tube. In other words, the built-in electronic circuit of the commonly-used induction-type fluorescent lamp structure is unworkable if the T5 or smaller lamp tube is applied thereto.

### SUMMARY OF THE INVENTION

In view of the above-mentioned conventional defects, a major object of the present invention is to provide a modularized transformation structure so that a T5 or smaller fluorescent lamp tube can be applied to an existing T8 lamp structure, wherein the T5 lamp tube is brighter, uneasy to twinkle, and it has a longer lifetime. As a result, the exiting T8 lamp structure can be provided with an optimum performance by using the T5 lamp tube.

In order to achieve the above-mentioned objects, a modularized transformation structure of the present invention is attachable to or detachable from the existing T8 lamp structure easily, wherein a T5 lamp tube is coupled with two lamp holders, and two adapters are coupled with both ends of a lamp tube so as to compensate for the insufficient length of the lamp tube. Accordingly, the T5 or smaller lamp tube is suitable for use in the T8 lamp holders. In addition, the performance of the T5 lamp tube is not affected by coupling with the T8 lamp structure.

### BRIEF DESCRIPTION OF THE DRAWINGS

FIG. 1 is a schematic diagram showing the wiring of the conventional fluorescent lamp structure.

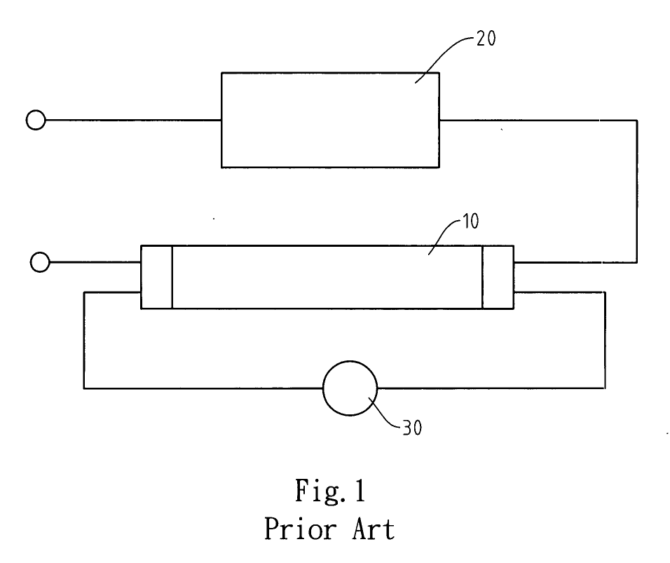

FIG. 2 is an elevational view of the present invention.

FIG. 3 is a schematic diagram showing the wiring of the present invention.

FIG. 4 is a partial enlarged, elevational view of the present invention.

FIG. 5 is a partial decomposed, elevational view of the present invention.

FIG. 6 is a decomposed, elevational view of FIG. 4.

### DETAILED DESCRIPTION OF THE PREFERRED EMBODIMENT

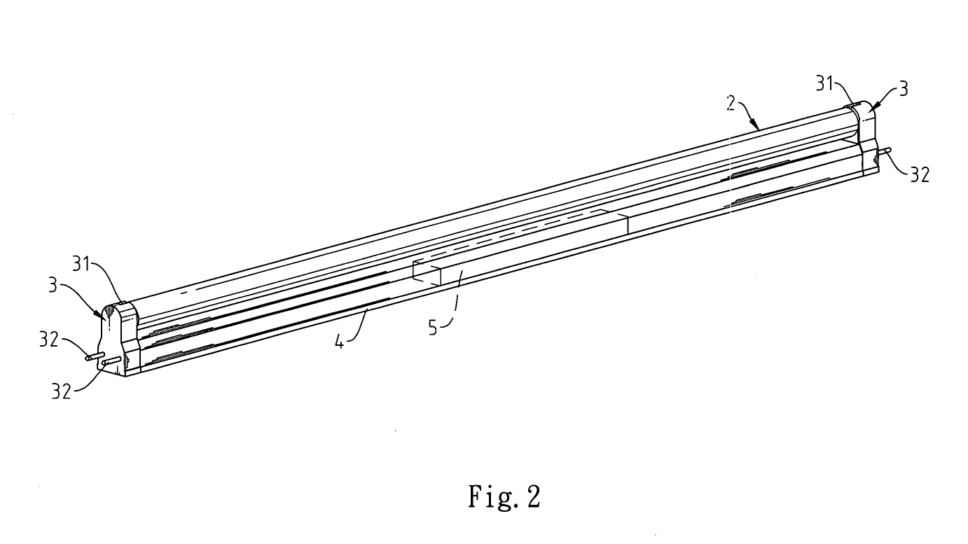

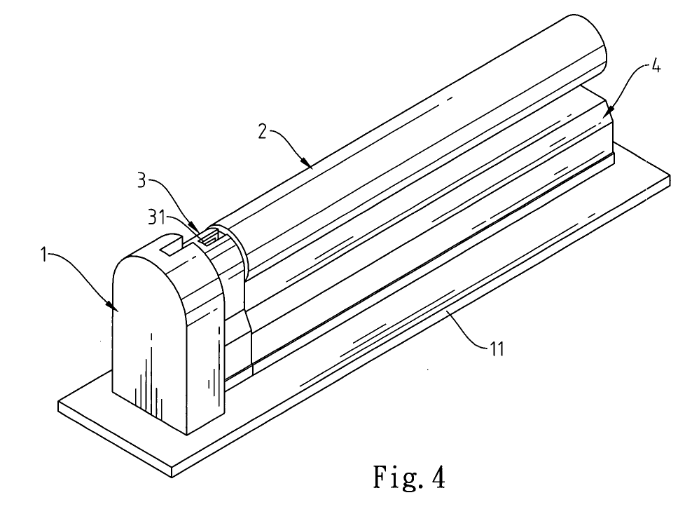

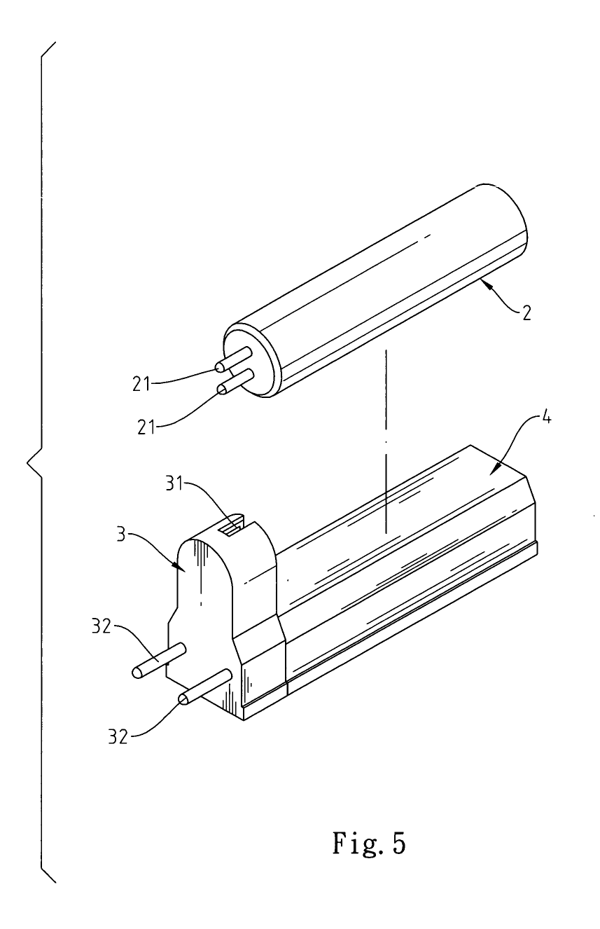

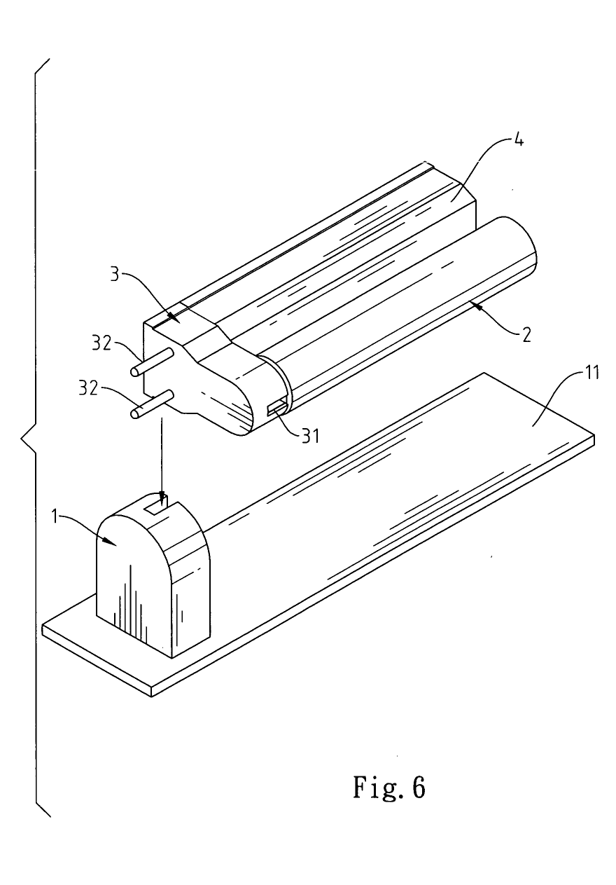

Referring to FIGS. 2, 4, 5 and 6, a modularized transformation structure for a lamp tube of the present invention is designed for coupling with the conventional T8 lamp holders 1 and the conventional lamp bracket 11 so that a T5 or smaller fluorescent lamp tube can be applied to an existing T8 lamp structure.

The modularized transformation structure of the present invention generally comprises two lamp holders 1, a lamp tube 2, two adapters 3, a lamp tube holder 4, and an electronic ballast 5, wherein the lamp tube 2 is a T5 lamp tube or a lamp tube with a smaller diameter. The adapters 3 are attached to both ends of the lamp tube holder 4, respectively. The adapters 3 have respective insertion trenches 31. Insertion terminals 32 are mounted on the outer laterals of these two adapters 3. Lamp pins 21 are mounted on both ends of the lamp tube 2 for insertion into the insertion trenches 31 so that the adapters 3 can be coupled with both ends of the lamp tube 2 easily to compensate for the insufficient length of the T5 lamp tube 2 and to provide the same length as the T8 lamp tube. Accordingly, the T5 lamp tube 2 is applicable to the conventional T8 lamp holders 1.

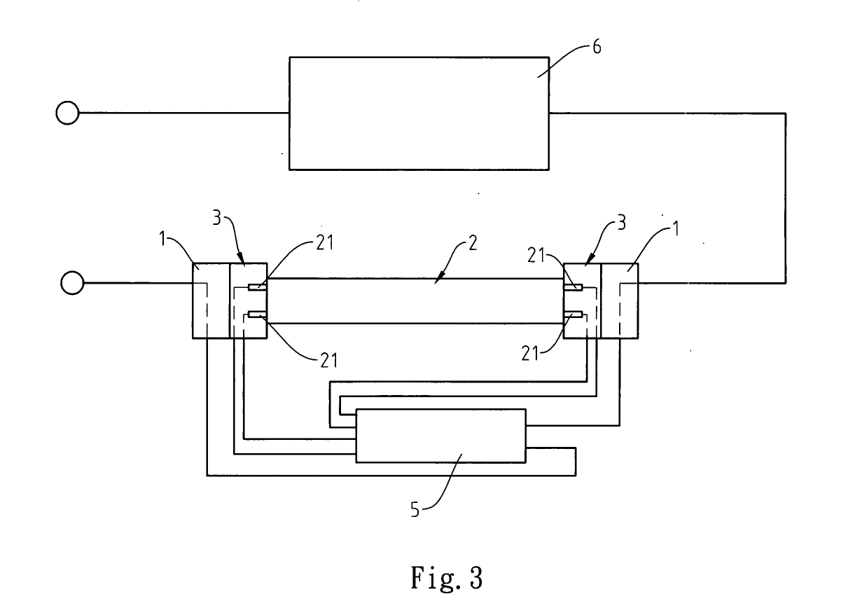

Referring to FIGS. 2, 3 and 6, the lamp tube 2 of the present invention is coupled with the adapters 3 on both ends of the lamp tube holder 4. Both of the adapters 3 have insertion terminals 32 on the outsides to compensate for the insufficient length of the T5 lamp tube 2 for coupling with the conventional lamp holders 1.

For the purpose of coupling the modularized transformation structure of the present invention with the conventional old-type lamp holders 1, the insertion terminals 32 of the adapters 3 on both ends of the lamp tube 2 are inserted into the lamp holders 1. The electronic ballast 5 is mounted on the inside of the lamp tube holder 4, wherein the wiring of the electronic ballast 5 is electrically connected to the output lamp pins 21 on both ends of the lamp tube 2. The outputs on both ends of the electronic ballast 5 are respectively connected with one lamp holder 1 and an inductive ballast 6 via the other lamp holder 1 so that the inductive ballast 6 provides the power-frequency voltage and the electronic ballast 5 provides the high-frequency voltage for actuating the lamp tube 2.

In accordance with the foregoing description, the modularized transformation structure of the present invention can reserve the original inductive ballast 6 of the original lamp structure, wherein only the original fluorescent lamp and actuator are detached therefrom, and there is no need to modify the wiring. Accordingly, it does not affect the original usage habit. There is only a need to replace the original fluorescent lamp tube with the new power-saving fluorescent lamp tube 2 by the use of these two adapters 3. There is no need to replace the whole induction-type fluorescent lamp structure so it is easy and quick to replace the lamp tube for thereby solving the conventional problem of environmental pollution caused by replacing the whole lamp structure.

As a result, the modularized transformation structure of the present invention is creative and novel and achieves the expected purposes and effects. In comparison with the conventional fluorescent lamp structure, the creative design of the present invention provides greater advantages and improvements.

What the invention claimed is:

1. A modularized transformation structure comprising:
two lamp holders;
a lamp tube;
two adapters;
a lamp tube holder; and
an electronic ballast,
said adapters being attached to both ends of said lamp tube holder, each of said adapters having an insertion trench for insertion thereinto of a plurality of lamp pins on each end of said lamp tube, each of said adapters having a plurality of insertion terminals on the outer lateral for thereby coupling with said lamp holders, said electronic ballast being mounted on the inside of said lamp tube holder for electrical connection with said lamp pins on both ends of said lamp tube, and said electronic ballast having two outputs on both ends for respective connection with one of said lamp holders and an inductive ballast via the other of said lamp holders.
